(19) United States
(12) Patent Application Publication
(10) Pub. No.: US 2008/0149887 A1
(43) Pub. Date: Jun. 26, 2008

(54) Electrode binder compositions and electrodes for lithium ion batteries and electric double layer capacitors

(76) Inventors: Jian Wang, Shizuoka-shi (JP); Masahiro Yamamoto, Shizuoka-shi (JP); Ronald Earl Uschold, West Chester, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/962,133

(22) Filed: Dec. 21, 2007

Related U.S. Application Data
(60) Provisional application No. 60/876,442, filed on Dec. 21, 2006.

(51) Int. Cl. H01M 4/38; C08L 27/14; C08L 27/16; H01M 4/48; C08L 27/18; C08L 73/00

(52) U.S. Cl. 252/182.1; 524/545; 524/546; 524/544; 524/599; 524/609; 524/610; 524/457

(57) ABSTRACT

An electrode binder composition comprising at least one metal chelate compound and at least one fluoropolymer. The binder composition used in a battery electrode improves the cohesion of the powdered active electrode material as well as the adhesion strength between the active material layer and the metallic current collector. The invention further relates to battery electrodes containing the binder composition for lithium ion secondary batteries and electric double layer capacitors.

### FIELD OF INVENTION

The invention relates to improved fluoropolymer binders for binding electrode material in the fabrication of battery electrodes and electric double layer capacitors.

### BACKGROUND OF THE INVENTION

In a lithium-ion secondary battery (LiB), a binder is required to keep the ion and electron conduction in the electrodes stable. At present, polyvinylidene fluoride (PVDF) is typically used for this binder. In the case of PVDF, however, delamination of the active mass (i.e., active electrode material such as powdered lithium composite oxides or carbon) occurs due to insufficient adhesion strength and flexibility, and thus there is a need for the development of new binders for electrodes.

In recent years, along with the development of small electrical devices such as cellular phones and video cameras, there have been active developments of small, light and high-output power supplies. The lithium-ion secondary battery is used widely as a battery meeting these requirements.

In the lithium-ion secondary battery, the positive electrode uses an aluminum foil as the current collector. Powdered lithium composite oxide such as LiCoO₂, LiNiO₂ or LiMn₂O₄ is mixed with a conductive material (such as carbon), a binder and a solvent to form a paste, which is coated and dried on the surface of the current collector. The negative electrode is prepared by coating a paste obtained by mixing carbon, a binder and a solvent onto a copper foil. To fabricate a battery, electrodes are layered in the order of the negative electrode, a separator (polymer porous film), the positive electrode and a separator and then coiled and housed in a cylindrical or rectangular can. In this battery fabrication process, the binder is necessary for bonding the active mass (electrode material) essential to the battery to the current collector of the electrodes. The adhesive and chemical properties of the binder have a great impact on the performance of the battery.

As a physical energy-storage device, the electric double layer capacitor (EDLC) also attracts much attention because it supports very high charge and discharge rates, a wide range of operating temperature, and long cycle life.

Similar to the electrode of LiB, the electrode of an EDLC is formed using a powdered active mass (electrode material). An electrode binder is used to glue the powdered active material together and bond them to metallic current collectors.

The performance requirements for an electrode binder, whether for a LiB electrode or an EDLC electrode, are enumerated below (<Japan Industrial materials> 1999.2):
1. Gluing the electrode material (powders in general) together.
2. Bonding the electrode material to the metallic current collector.
3. Maintaining the ionic and electric conductivity stable under cyclical charging and discharging.
4. Preparing a homogenous paste of the electrode material for processability.

Currently, a fluorinated polymer such as polyvinylidene fluoride (PVDF) or polytetrafluoroethylene (PTFE) is employed as the binder resin in most LiBs for its electrochemical stability and chemical resistance.

An example of using fluorinated polymers as binder resins is disclosed in Japanese Laid-Open Patent Application (JP-A) H4-249860 which relates to a non-aqueous electrolyte battery using PVDF as the anode binder. JPA 2001-266854 and JPA 2001-216957 disclose a method of making a non-aqueous electrolyte battery using a PTFE-FEP composition as the electrode binder. JPA 2002-313345 discloses a non-aqueous electrolyte battery using a fluorinated copolymer having a molecular weight (Mw) in the range of 300,000-600,000 as the electrode binder.

However, fluorinated polymers may not provide sufficient cohesion and adhesion between the polymeric binder and various inorganic materials such as metal, metal oxide or carbon because of their low intermolecular forces (Van der Waals forces), which result in weak interactions between fluoropolymer molecules or between fluoropolymer molecules and other molecules.

One means for increasing cohesion and adhesion of the fluorinated polymer binder is increasing the amount of polymeric binder. However, an increased amount of the binder resin results in increased electrical resistance of an electrode because the surfaces of the electrode material are covered by electrical insulating binder resin. In addition, the more the binder resin is used, the less the active mass is able to be filled in the electrode, which results in decreased energy density.

There remains a desire in the fabrication of battery electrodes to improve the cohesion of the powdered active electrode material using fluoropolymer binders as well as the adhesion strength between the active electrode material layer and the metallic current collector.

### BRIEF SUMMARY OF THE INVENTION

The present invention provides an electrode binder composition, comprising at least one metallic chelate compound and at least one fluoropolymer. In one preferred embodiment of the invention, the fluoropolymer is a homopolymer or a copolymer prepared from at least one monomer selected from the group consisting of vinyl fluoride, vinylidene fluoride, tetrafluoroethylene, trifluoroethylene, chlorotrifluoroethylene, fluorinated vinyl ethers, fluorinated alkyl acrylates/methacrylates, perfluoroolefins having 3-10 carbon atoms, perfluoro C1-C8 alkyl ethylenes and fluorinated dioxoles. More preferably, the electrode binder composition is a vinyl fluoride based copolymer. In other preferred embodiments, the metal chelate is a titanium chelate compound or a zirconium chelate compound.

The binder composition of this invention used in a battery electrode improves the cohesion of the powdered active mass (electrode material) as well as the adhesion strength between the active material layer and the metallic current collector, while maintaining good chemical and electrochemical stability. The electrode composition also provides excellent dispersibility so that it can be mixed with active masses and conductive agents homogeneously without a gelatinization reaction at room temperature.

The present invention also provides an electrode comprising active electrode material and the binder composition of the invention which may be advantageously used in lithium ion secondary batteries and electric double layer capacitors.

### DETAILED DESCRIPTION OF THE INVENTION

The electrode binder composition of this invention comprises at least one metallic chelate compound and at least one fluoropolymer.

### Fluoropolymer

The fluoropolymer of the present invention means a homopolymer or a copolymer prepared from at least one fluorinated monomer. Hydrocarbon-type monomers may also be included.

Preferred fluorinated monomers include fluoroolefins such as vinyl fluoride (VF), vinylidene fluoride (VdF), tetrafluoroethylene (TFE), trifluoroethylene (TrFE), chlorotrifluoroethylene (CTFE), fluorinated vinyl ethers, fluorinated alkyl acrylates/methacrylates, perfluoroolefins having 3-10 carbon atoms, perfluoro C1-C8 alkyl ethylenes and fluorinated dioxoles.

The vinyl fluoride-based copolymer is especially preferred as the aforementioned fluoropolymer. This copolymer may be prepared by copolymerizing VF monomer and at least one vinyl monomer. The vinyl fluoride-based copolymers usually possess good flexibility and mechanical strength, which are helpful characteristics for a binder resin. This VF-based copolymer preferably contains about 10 to about 90 mol % vinyl fluoride. If the VF content is less than about 10 mol %, the flexibility and mechanical strength of the copolymer may be insufficient; on the other hand, if the VF content is higher than about 90 mol %, the chemical or thermal resistance of the copolymer may become insufficient. More preferably, the VF content of the copolymer is about 30 to about 75 mol % vinyl fluoride, most preferably, about 40 to about 70 mol % vinyl fluoride.

Preferred VF copolymers comprise at least two highly fluorinated monomers, at least one of the highly fluorinated monomers introducing into the polymer a side chain of at least one carbon atom. Preferred highly fluorinated monomers which introduce into the polymer a side chain of at least one carbon atom useful for this invention include perfluoroolefins having 3-10 carbon atoms, perfluoroC₁-C₈alkyl ethylenes, fluorinated dioxoles, and fluorinated vinyl ethers of the formula CY₂═CYOR or CY₂═CYOR′OR wherein Y is H or F, and —R and —R′ are independently completely-fluorinated or partially-fluorinated alkyl or alkylene group containing 1-8 carbon atoms and are preferably perfluorinated. Preferred —R groups contain 1-4 carbon atoms and are preferably perfluorinated. Preferred —R′— groups contain 2-4 carbon atoms and are preferably perfluorinated. Preferably, Y is F. For the purposes of the present invention, by highly fluorinated is meant that 50% or greater of the atoms bonded to carbon are fluorine excluding linking atoms such as O or S.

Especially preferred highly fluorinated monomers which introduce into the polymer a side chain of at least one carbon atom are perfluoroolefins, such as hexafluoropropylene; perfluoroC₁-C₈alkyl ethylenes, such as perfluorobutyl ethylene; or perfluoro(C₁-C₈alkyl vinyl ethers), such as perfluoro(ethyl vinyl ether). Preferred fluorinated dioxole monomers include perfluoro-2,2-dimethyl-1,3-dioxole (PDD) and perfluoro-2-methylene-4-methyl-1,3-dioxolane (PMD). Hexafluoroisobutylene is another highly fluorinated monomer useful in this invention.

Preferably, the VF copolymer comprises about 1 to about 15 mol %, more preferably about 5 to about 10 mol % of at least one highly fluorinated monomer which introduces into the polymer a side chain of at least one carbon atom.

An especially preferred embodiment of the VF copolymer comprises 30-75 mol % vinyl fluoride and 1 to 15 mol % of at least one highly fluorinated monomer which introduces into the polymer a side chain of at least one carbon atom and the balance being at least one C₂ olefin selected from the group of vinylidene fluoride, tetrafluoroethylene, trifluoroethylene, and chlorotrifluoroethylene. Most preferably, the C₂ olefin is tetrafluoroethylene.

Preferred fluoropolymers may contain at least one functional group, such as hydroxyls, thiols, carbonyls, carboxylic acids, carbonates, sulfonyls, sulfonic acids, sulfonates, phosphoric acids, boric acids, esters, amines, amides, nitriles, epoxies and isocyanates. It is advantageous for such groups to be introduced into the fluoropolymer in functionalized monomers having a side chain such as those described above as preferred for VF copolymers. This fluoropolymer with functional groups may crosslink with metal chelate compounds to form a 3-D network at elevated temperature so as to improve the cohesion and adhesion.

The preparation methods of the fluoropolymers used in the electrode binder composition of this invention are not particularly limited. The usual polymerization methods are preferable, such as the emulsion polymerization, the suspension polymerization, the solution polymerization, and mass polymerization. More preferably, the fluoropolymers are prepared by emulsion polymerization by polymerizing fluorinated monomer in water with a water-soluble free-radical initiator such as alkali metal or ammonium persulfate salt at 60-100 degrees C. and reactor pressures of 1-12 MPa (145-1760 psi). In this case, the pH of the latex can be controlled by using buffer agents such as phosphates, carbonates, and acetates. In order to adjust the molecular weight of the fluoropolymers, a chain transfer agent may be used if needed, such as ethane, cyclohexane, methanol, ethanol, isopropanol, ethyl malonate, acetone, and etc. When the binder composition is to be dispersed in an organic solvent for use in electrode manufacture, the fluoropolymer is preferably isolated from the latex and dried.

### Metal Chelate Compound

The metal chelate compound of the electrode binder composition of this invention means a compound in the form of a heterocyclic ring, containing an electron-pair-acceptor metal ion attached by coordinate bonds to at least two electron-pair-donor nonmetal ions. The nonmetal ions attached to the metal ion are preferably selected from the elements in Group V or Group VI of the periodic table for their strong nonmetal properties. The most preferable three elements are N, O, and S.

Preferred metal chelate compounds used in the electrode binder composition of this invention are titanium chelate or zirconium chelate compounds. Although most of the metals in the periodic table may be used in forming the chelate compound, the metals with strong chemical resistance are preferable because of their intended use in a strong oxidation-reduction environment of LiBs or EDLCs. The metal chelate compound in the electrode binder composition may convert to its corresponding metal oxide form after heat-treatment (higher than 100° C.) while the organic chelate groups are eliminated, with the result that the binder content in the resultant electrode coating decreases after heat-treatment.

The metal chelate compound and fluoropolymer used in the electrode binder composition of this invention are preferably dispersed in water or an organic solvent to form a solution or an organosol, which may be mixed with active material (including conductive agents) to form a homogenous paste. Preferable organic solvents are polar organic solvents, such as N-methyl-2-pyrrolidone (NMP), N,N-dimethyl formamide (DMF), N,N-dimethyl acetamide (DMAc), acetone, methylethyl ketone (MEK), tetrahydrofuran (THF), and dimethyl sulfoxide (DMSO). High-boiling point solvents are more preferable, such as NMP, DMF, DMAc and DMSO.

### Active Electrode Material

Electrodes in accordance with the invention comprise active electrode material. Active electrode material for secondary batteries include any powdered electrode material useful as electrodes for secondary batteries including any of various metals and metal oxides which typically is mixed with a conductive material such as carbon. For lithium ion secondary batteries, lithium composite oxides such as LiCoO₂, LiNiO₂, or LiMn₂O₄ are preferred. For use in EDLC, preferred active electrode material include carbonaceous material such as graphite and ketjen black. Such carbonaceous material preferably have a number average particle size of about 10 to about 1000 nm. A preferred class of active electrode material are powders selected from the group consisting of metal, metal oxide, and carbon.

### LIB's and EDLC's

Preferred electrodes for lithium ion secondary battery (LIB) or electric double layer capacitor (EDLC) may be formed by coating a mixture of the electrode binder composition of this invention, active electrode material (including conductive agents) on a metallic current collector. For LiBs, preferred active material of positive electrodes are LiCoO₂, LiNiO₂, or LiMn₂O₄, and preferred active material of negative electrodes is carbonaceous material. Preferred conductive agents are powdered carbonaceous materials, of which average diameters are preferably in the range of 10-1000 nm. A preferred current collector of a positive electrode is aluminum, while a preferred current collector of an negative electrode is copper. For EDLCs, a carbonaceous material is preferably used as the active material, and an aluminum foil is preferably used as the current collector.

### Test Methods

### Peel Strength of the Electrode Coatings

An adhesive tape (3M Scotch™ 898) is applied to the surface of the electrode coating and pressed by a rubber. The peel strength is measured by a 180 degree-peeling test according to JIS K6854 using TENSILON (UTM-1T available from Toyo Baldwin).

### Adhesion of Electrode Binder Compositions to Al

A solution or dispersion of the electrode binder composition of this invention is prepared and placed in an aluminum cup (AsOne No. 107). Then, it is heated at 150° C. for 2 hours under 100 torrs pressure to form a film on the surface of an Al cup. The adhesion condition between the resultant film and the Al is observed visually.

### EXAMPLES

### Preparation of a Vf-Based Fluoropolymer, Sample A

The VF-based fluoropolymers are produced by a method similar to that described by R. E. Uschold, U.S. Pat. No. 6,242,547 (2001), to make a VF/TFE/HFP terpolymer. A stirred jacketed horizontal stainless steel autoclave of 3.8 L capacity is used as the polymerization vessel. The autoclave is equipped with instrumentation to measure temperature and pressure and with a compressor that could feed monomer mixtures to the autoclave at the desired pressure. The autoclave is filled with deionized water containing 0.2% ammonium perfluorooctanoate to 70-80% of its volume, then pressured to 2.8 MPa and vented with nitrogen three times then with TFE three times. The water is heated to 90° C., the agitator is started and TFE, VF and HFP are added in the desired ration to bring the autoclave pressure to 2.8 MPa. Initiator solution is injected to provide 125 mL ammonium persulfate solution at a concentration of 10 g/L. The initiator solution is then fed at a rate of 1 mL/min for the duration of the run. Additional TFE, VF and HFP are fed to the reactor during the run to maintain a constant pressure until a quantity sufficient to produce the desired dispersion solids, 20-25%, is reached. At that point, monomer feeds are stopped, cooling water is passed through the autoclave jacket and excess monomers are vented. The autoclave is evacuated and purged with nitrogen three times to remove any residual monomer then the polymer dispersion is drained from the autoclave. The polymer is isolated by freezing, then thawing the dispersion to yield polymer crumb, which is collected on a suction filter. The filter cake is washed with deionized water to remove surfactant and initiator residues, then dried in an air oven at 90-100° C.

A VF/TFE/HFP terpolymer, sample A is obtained, which comprises 69.8 mol % of VF units, 22.8 mol % of TFE units and 7.4 mol % of HFP units.

### Preparation of Fluoropolymers with Functional Groups, Sample B, C, D, E, F

The fluoropolymers with functional groups, named as sample B, C, D, E, and F, are produced by the method described below. The compositions of the polymers produced are indicated in Table 3.

A horizontal stainless steel autoclave of 7.6 L (2 US gallons) capacity equipped with a stirrer and a jacket is used as a polymerization reactor. Instruments for measuring temperature and pressure and a compressor for supplying the monomer mixtures to the autoclave at a desired pressure are attached to the autoclave.

The autoclave is filled with deionized water containing 15 g of 6.2-TBS (prepared as described in Baker et al., U.S. Pat. No. 5,688,884) to 70 to 80% of its capacity, and is followed by increasing the internal temperature to 90° C. Then, the autoclave is purged of air by pressurizing three times to 3.1 Mpa (450 psig) using nitrogen. After purging, the autoclave is charged with the monomer mixtures having the composition shown in the following Table 1 until the internal pressure reaches 3.1 MPa (450 psig).

TABLE 1

| | Composition of Pre-charged Monomer (wt %) | | | | |
|---|---|---|---|---|---|
| Sample No. | TFE | VF | PPVE | PEVE | EVE-OH |
| B | 52.7 | 27.7 | 14.8 | / | 4.8 |
| C | 54.1 | 28.4 | / | 12.6 | 4.9 |
| D | 51.1 | 26.8 | / | 18.1 | 3.9 |
| E | 52.9 | 27.8 | / | 15.0 | 4.3 |
| F | 49.7 | 26.2 | / | 19.6 | 4.5 |

An initiator solution is prepared by dissolving 20 g of ammonium persulfate in 1 L of deionized water. This initiator solution is supplied into the reactor at a rate of 25 ml/minute for 5 minutes, and then the rate is lowered and maintained at 1 ml/minute during the reaction.

When the internal pressure drops to 3.0 MPa, the makeup monomer mixtures shown in Table 2 are supplied to keep the pressure constant.

TABLE 2

| | Composition of Makeup Monomer (wt %) | | | | |
|---|---|---|---|---|---|
| Sample No. | TFE | VF | PPVE | PEVE | EVE-OH |
| B | 54.6 | 34.0 | 7.4 | / | 4.0 |
| C | 55.3 | 34.7 | / | 6.0 | 4.0 |
| D | 54.8 | 34.2 | / | 8.0 | 3.0 |
| E | 54.6 | 34.0 | / | 7.4 | 4.0 |
| F | 53.8 | 33.8 | / | 8.9 | 3.5 |

Composition of this makeup supply is different from that of the pre-charged mixture because of different reactivity of each monomer. Since the composition thereof is selected so that the monomer composition in the reactor is kept constant, a product having a uniform composition is obtained.

Monomers are supplied to the autoclave until a solid content in the produced latex reaches about 20%. When the solid content reaches a predetermined value, supply of the monomers is immediately stopped, then the content of the autoclave is cooled and unreacted gases in the autoclave are purged off.

To the resulting latex, 15 g of ammonium carbonate dissolved in water per 1 L of latex and then 70 mL of HFC-4310 (1,1,1,2,3,4,4,5,5,5-decafluoropentane) per 1 L of latex are added while stirring at high speed, followed by isolation of the polymer by filtration. The polymer is washed with water and dried at 90 to 100° C. in a hot-air dryer. Compositions and melting points of the produced polymers are shown in Table 3.

The resulting VF copolymer is dissolved in NMP at 55 to 60° C. using a water-bath incubator and then cooled to room temperature (25° C.), and solubility of the resin, at which a stable clear solution is obtained, is measured. The results are shown in Table 3.

TABLE 3

| | Composition of Polymer (mole %) | | | | | Melting | Solubility |
|---|---|---|---|---|---|---|---|
| Sample | | | | | EVE- | Point | (in NMP) |
| No. | TFE | VF | PPVE | PEVE | OH | (° C.) | 25° C. |
| B | 39.9 | 57.1 | 2.2 | / | 0.75 | 174 | 8-10% |
| C | 42.3 | 55.2 | / | 1.7 | 0.78 | 178 | 8-10% |
| D | 42.7 | 54.3 | / | 2.5 | 0.57 | 174 | 8-10% |
| E | 43.3 | 53.8 | / | 2.2 | 0.65 | 175 | 8-10% |
| F | 41.2 | 55.3 | / | 2.8 | 0.65 | 171 | 10-13% |

### Examples 1-6

### Comparative Examples 1-2

### Preparation of Electrode Binder Compositions

The sample A above-mentioned is well dispersed in NMP to form an organosol at 50-70 degree C. A powdered PVDF (KF #1100, available from Kureha Chemicals, Ltd.) is dissolved in NMP to form a solution at 50-70 degree C. A zirconium chelate compound, citric acid diethyl ether zirconate, is dissolved in n-propanol to form a 70% solution (DuPont™ Tyzor® ZEC, ZrO₂ content: 13.1%). The solution of zirconium chelate is added into the organosol of sample A and the solution of PVDF to form uniform electrode binder compositions. The composition data is presented in Table 4.

### Preparation of Positive Electrodes for LiBs

3 weight parts of the electrode binder compositions (calculated as solids) are mixed with 95 weight parts of LiCoO₂ (Nippon Kagaku Industries, Ltd) and 2 weight parts of powdered carbon (conductive agent) in NMP to form a generous paste by using a homogenizer (ULTRA-TURAX T25, IKA Japan). The pastes are coated on Al foil (current collector, thickness: 20 μm) using a film applicator, then dried at 120-130 degree C. for at least 3 hours under 100-200 torrs pressure to form positive electrodes for LiBs. The thicknesses of the electrode coatings are controlled in a range of 40-50 μm.

### Peel Strength of Positive Electrode Coatings for LiBs

Adhesive tapes (3M Scotch™ 898) are adhered closely on the surfaces of the above-mentioned electrodes and pressed by a rubber. The peel strength of the electrodes coatings are measured by a 180 degree-peeling test according to JIS K6854 using TENSILON (UTM-1T available from Toyo Baldwin). Data of peel strength are shown in Table 4.

TABLE 4
Peel strength of positive electrode coatings of LiBs

| | | | Zirconium chelate usage | Peeling |
|---|---|---|---|---|
| | | Resin usage | (weight part in | strength |
| | Sample | (weight part) | equivalent ZrO2 content) | (g/cm) |
| Ex. | | | | |
| 1 | A | 2.9 | 0.1 | 217 |
| 2 | A | 2.8 | 0.2 | 270 |
| 3 | A | 2.7 | 0.3 | 261 |
| 4 | PVDF | 2.9 | 0.1 | 102 |
| 5 | PVDF | 2.8 | 0.2 | 113 |
| 6 | PVDF | 2.7 | 0.3 | 121 |
| Comp. Ex. | | | | |
| 1 | A | 3 | 0 | 199 |
| 2 | PVDF | 3 | 0 | 77 |

### Examples 7-12

### Comparative Examples 3-4

### Preparation of Negative Electrodes for LiBs

The respective LiB negative electrodes are obtained by the similar method of producing positive electrodes. MCMB (Meso Carbon Micro Beads, Osaka Gas Chemicals Co., Ltd.) is used as the active material. The ratio of active material to binder composition is 97/3 wt/wt. A copper foil (thickness: 20 μm) is used as the current collector for negative electrodes of LiBs.

### Peel Strength of Negative Electrode Coatings For LiBs

The peel strength of LiB negative electrode coatings are measured by the same method used in Examples 1-5. The results are shown in Table 5.

TABLE 5
Peel strength of negative electrode coatings of LiBs

| | | | Zirconium chelate usage | Peeling |
|---|---|---|---|---|
| | | Resin usage | (weight part in | strength |
| | Sample | (weight part) | equivalent ZrO2 content) | (g/cm) |
| Ex. | | | | |
| 7 | A | 2.9 | 0.1 | 98 |
| 8 | A | 2.8 | 0.2 | 113 |
| 9 | A | 2.7 | 0.3 | 116 |
| 10 | PVDF | 2.9 | 0.1 | 33 |
| 11 | PVDF | 2.8 | 0.2 | 46 |
| 12 | PVDF | 2.7 | 0.3 | 53 |
| Comp. Ex. | | | | |
| 3 | A | 3 | 0 | 75 |
| 4 | PVDF | 3 | 0 | 17 |

### Examples 13

### Preparation of Electrodes for EDLCS

The electrodes for EDLCs are produced by a similar method as in Examples 1-12. MCMB (Meso Carbon Micro Beads, Osaka Gas Chemicals Co., Ltd.) is used as the active material. The ratio of active material to binder composition is 97/3 wt/wt. An aluminum foil (thickness: 20 μm) is used as the current collector.

### Examples 14-28

### Comparative Examples 5-9

### Adhesion of Electrode Binder Compositions to Al

The fluoropolymers with functional groups, sample B, C, D, E and F, are dissolved in NMP to form 10 wt % solutions. A titanium chelate compound, titanium acethyl acetonate (DuPont™ Tyzor® AA) is diluted in NMP to form a 10 wt % solution. A series of electrode compositions is produced by mixing the two solutions uniformly. 3 g of the mixed solutions is placed into an aluminum cup and heated at 150° C. for 2 hours under 100 torrs pressure, then cooled to room temperature. The adhesion conditions between the obtained binder resin films and the aluminum substrates are observed visually. The results are shown in Table 6.

TABLE 6
Adhesion of Electrode Binder Compositions to Al

| | | | Fluoropolymer | Titanium acetyl | |
|---|---|---|---|---|---|
| | | | solution | acetonate solu- | |
| | | | (10 wt % in | tion (10 wt % | Adhesion |
| | | | NMP) usage | in NMP) usage | evalu- |
| | | Sam- | (parts by | (parts by | ation |
| | | ple | weight) | weight) | test |
| Ex. | 14 | B | 100 | 1 | Fair |
| | 15 | C | 100 | 1 | Fair |
| | 16 | D | 100 | 1 | Fair |
| | 17 | E | 100 | 1 | Fair |
| | 18 | F | 100 | 1 | Fair |
| | 19 | B | 100 | 3 | Good |
| | 20 | C | 100 | 3 | Good |
| | 21 | D | 100 | 3 | Good |
| | 22 | E | 100 | 3 | Good |
| | 23 | F | 100 | 3 | Good |
| | 24 | B | 100 | 5 | Good |
| | 25 | C | 100 | 5 | Good |
| | 26 | D | 100 | 5 | Good |
| | 27 | E | 100 | 5 | Good |
| | 28 | F | 100 | 5 | Good |
| Comp. | 5 | B | 100 | 0 | Poor |
| Ex. | 6 | C | 100 | 0 | Poor |
| | 7 | D | 100 | 0 | Poor |
| | 8 | E | 100 | 0 | Poor |
| | 9 | F | 100 | 0 | Poor |

Poor: Separated.
Fair: Partly separated.
Good: No separation.

What is claimed is:

1. An electrode binder composition for lithium ion secondary battery or electric double layer capacitor, comprising at least one metal chelate compound and at least one fluoropolymer.

2. The electrode binder composition of claim 1, wherein said fluoropolymer is a homopolymer or a copolymer prepared from at least one monomer selected from the group consisting of vinyl fluoride, vinylidene fluoride, tetrafluoroethylene, trifluoroethylene, chlorotrifluoroethylene, fluorinated vinyl ethers, fluorinated alkyl acrylates/methacrylates, perfluoroolefins having 3-10 carbon atoms, perfluoro C1-C8 alkyl ethylenes and fluorinated dioxoles.

3. The electrode binder composition of claim 1, wherein said fluoropolymer is a vinyl fluoride based copolymer.

4. The electrode binder composition of claim 3, wherein the vinyl fluoride content of the copolymer is about 10 to about 90 mol %.

5. The electrode binder composition of claim 3, wherein the vinyl fluoride content of the copolymer is about 30 to about 75 mol %.

6. The electrode binder composition of claim 3, wherein the vinyl fluoride content of the copolymer is about 40 to about 70 mol %.

7. The electrode binder composition of claim 3, wherein the vinyl fluoride based copolymer comprises at least two highly fluorinated monomers, at least one of the highly fluorinated monomers which introduces into the polymer a side chain of at least one carbon atom.

8. The electrode binder composition of claim 7, wherein said highly fluorinated monomers which introduce into the polymer a side chain of at least one carbon atom comprise perfluoroolefins having 3-10 carbon atoms, perfluoroC₁-C₈alkyl ethylenes, fluorinated dioxoles, and fluorinated vinyl ethers of the formula CY₂═CYOR or CY₂═CYOR′OR wherein Y is H or F, and —R and —R′ are independently completely-fluorinated or partially-fluorinated alkyl or alkylene group containing 1-8 carbon atoms and are preferably perfluorinated.

9. The electrode binder composition of claim 7, wherein said vinyl fluoride copolymer comprises about 1 to about 15 mol % of said at least one highly fluorinated monomer which introduces into the polymer a side chain of at least one carbon atom.

10. The electrode binder composition of claim 7, wherein said copolymer comprises 30-75 mol % vinyl fluoride and 1 to 15 mol % of at least one highly fluorinated monomer which introduces into the polymer a side chain of at least one carbon atom and the balance being at least one C₂ olefin selected from the group of vinylidene fluoride, tetrafluoroethylene, trifluoroethylene, and chlorotrifluoroethylene.

11. The electrode binder composition of claim 10, wherein said C₂ olefin in said vinyl fluoride copolymer comprises 1 tetrafluoroethylene.

12. The electrode binder composition of claim 1, wherein said fluoropolymer contains at least one functional group selected from the group consisting of hydroxyls, thiols, carbonyls, carboxylic acids, carbonates, sulfonyls, sulfonic acids, sulfonates, phosphoric acids, boric acids, esters, amines, amides, nitriles, epoxies and isocyanates.

13. The electrode binder composition of claim 1, wherein said metal chelate compound is a titanium chelate compound.

14. The electrode binder composition of claim 1, wherein said metal chelate compound is a zirconium chelate compound.

15. The electrode binder composition of claim 1, wherein said metal chelate compound and fluoropolymer are dispersed in water to form a dispersion.

16. The electrode binder composition of claim 1, wherein said metal chelate compound and fluoropolymer are dispersed in an organic solvent to form a solution or an organosol.

17. An electrode for lithium ion secondary battery or electric double layer capacitor comprising active electrode material and an electrode binder, wherein said electrode binder comprises the electrode binder composition of claim 1.

18. The electrode of claim 17 wherein said active electrode material is powder selected from the group consisting of metal, metal oxide, and carbon.
